(19) United States
(12) Patent Application Publication
(10) Pub. No.: US 2022/0368275 A1
(43) Pub. Date: Nov. 17, 2022

(54) MULTIFUNCTIONAL BASE, AND BAG

(71) Applicant: ZTARX Corporation Limited, Shenzhen (CN)

(72) Inventor: Song Ping Chen, Shenzhen (CN)

(21) Appl. No.: 17/813,613

(22) Filed: Jul. 20, 2022

Related U.S. Application Data
(63) Continuation-in-part of application No. 16/435,581, filed on Jun. 10, 2019, now Pat. No. 11,425,978.

(30) Foreign Application Priority Data
Jul. 21, 2021 (CN) 202121665212.3

(51) Int. Cl. H02S 20/30; A45C 15/06; A45C 13/00

(52) U.S. Cl. CPC H02S 20/30; A45C 15/06; A45C 13/001; A45C 13/002; A45C 2003/008

(57) ABSTRACT

Provided is a multifunctional base, which includes a first cover, having a first connecting edge made of flexible material and extended along a periphery of the first cover, the first connecting edge is configured to sealingly connect the multifunctional base with an object; and a second cover, the second cover is connected with first cover to define a receiving space. A bag is also provided.

### FIELD

The subject matter herein generally relates to bags, and particularly relates to a multifunctional base, and a bag.

### BACKGROUND

Along with the improvement of the living standard, more and more people pursue freely enjoyed outdoor life after busy work. In the outdoor activities, we naturally need to carry a plurality of private articles, so that better and more convenient storage tools become necessary articles for the outdoor activities, and real outdoor activities often need more things: for example, water-proof backpacks, water-proof LED lamps, water-proof sound boxes, chargers and the like, so as to meet the necessary requirements of outdoor life of people. However, the existing bags on the market can only meet the single water-proof function and storage function and cannot meet the multiple requirements of consumers, so that a design of a multifunctional integrated bag convenient to storage and having the functions of waterproofness, lighting, sound boxes and charging electronic equipment in emergency becomes a product rigidly demanded by the current consumer market.

### SUMMARY

In order to resolve above-mentioned deficiencies, the present disclosure provides

a multifunctional base and a bag, the bag is convenient to carry and has multiple functions.

A multifunctional base includes a first cover, having a first connecting edge made of flexible material and extended along a periphery of the first cover, the first connecting edge is configured to sealingly connect the multifunctional base with an object; and a second cover, the second cover is connected with first cover to define a receiving space.

In at least one embodiment, the second cover includes: a second connecting edge, made of flexible material and extended along a periphery of the second cover, the first connecting edge is sealingly connected with the second connecting edge.

In at least one embodiment, the multifunctional base further includes: a fixing plate, received in the receiving space; and a bottom shell, received in the receiving space and connected with the fixing plate to define a cavity.

In at least one embodiment, the multifunctional base further includes: a control module, received in the cavity; and a power module, at least partially received in the cavity and electrically connected with the control module.

In at least one embodiment, the power module includes: a solar panel, the solar panel is arranged on the fixing plate and the first cover is at least transparent; or the first cover defines a first through hole, and the solar panel is arranged on the fixing plate and exposed from the first through hole.

In at least one embodiment, the power module further includes: a rechargeable battery, electrically connected with the solar panel and received in the cavity.

In at least one embodiment, the multifunctional base further includes: an operation panel, electrically connected with the power module and the control module, the operation panel is arranged on the fixing plate and attached with the first cover; or the first cover defines a first through hole, and the operation panel is arranged on the fixing plate and exposed from the first through hole.

In at least one embodiment, the multifunctional base further includes: a speaker, electrically connected with the power module and the control module, the speaker is arranged on the fixing plate and attached with the first cover; or the first cover defines a second through hole, the speaker is arranged on the fixing plate and exposed from the second through hole.

In at least one embodiment, the multifunctional base further includes: a light-emitting module, electrically connected with the power module and the control module, the light-emitting module is received in the cavity, and the first cover is at least partially transparent. Or the multifunctional base further includes a plurality of light-emitting modules, spaced apart from each other and electrically connected with the power module and the control module, the light-emitting modules are arranged on the first cover.

A bag includes the multifunctional base and a bag body, the multifunctional base is sealingly connected with the bag body.

In at least one embodiment, the multifunctional base is sealingly connected with a top surface of the bag body; or the multifunctional base is sealingly connected with a front surface of the bag body.

In at least one embodiment, the bag further includes: an insulating element, for thermal insulation, the insulating element defines a receiving groove, the multifunctional base is received in the receiving groove, and the first connecting edge is sealingly connected with a periphery of the receiving groove by the first connecting edge and exposed from the bag body.

In at least one embodiment, the bag body includes: a waterproof element, for preventing water from penetrating into the: bag, the waterproof element is arranged adjacent to the insulating element, the waterproof element defines a third through hole communicated with the receiving groove, the multifunctional base is exposed from the third through hole and sealingly connected with a periphery of the third through hole by the first connecting edge.

In at least one embodiment, the bag further includes: a first carriage bag, detachably attached with the bag body, the multifunctional base is sealingly connected with the first carriage bag by the first connecting edge.

In at least one embodiment, the bag further includes: a second carriage bag, detachably attached with the bag body; and a third carriage bag, detachably attached with the second carriage bag, the multifunctional base is sealingly connected with third carriage bag by the first connecting edge.

In at least one embodiment, the bag body includes: a first protecting cover; and a second protecting cover, connected with the first protecting cover, the first protecting cover and the second protecting cover are configured to cover an opening of the bag body.

In at least one embodiment, the bag body includes a one piece structure, the bag body includes: a plurality of folding portions, arranged at corners of the bag body respectively; a plurality of side walls, each side wall is connected with one corresponding folding portion; and a bottom wall, connected with the side walls, the folding portions are folded to remain the side walls to be in an upright state, so that the folding portions, the side walls, and the bottom wall cooperatively form the bag body.

In at least one embodiment, each of the folding portions includes: a diagonal line, two connecting sides; and a connecting structure, the folding portion is folded along the diagonal line, and the connecting sides are connected together by the connecting structure.

In at least one embodiment, the bag includes a fourth carriage bag, the fourth carriage bap includes: a supporting rotatably connected with an inner wall of the fourth carriage bag, the supporting plate defines a via hole; and at least one receiving element, connected with the supporting plate, the receiving element defines a receiving space communicated with the via hole.

In at least one embodiment, the fourth carriage bag includes: a connecting belt, one end of the connecting belt is connected with the inner wall of the fourth carriage bag, another end of the connecting belt is connected with the supporting plate.

In the present disclosure, the multifunctional base can be configured to sealingly connect the multifunctional base with an object by the first connecting edge. The first cover and the second cover cooperatively form the receiving space, some components, such as power module, control module, operation panel, speaker, light-emitting module, and the like, can be received in the receiving space or arranged on the first cover, so that the multifunctional base can provide user multi-functions.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic view of a multifunctional base according to an embodiment of the present disclosure.

FIG. 2 is an exploded view of the multifunctional base of FIG. 1.

FIG. 3 is a structural block view of the multifunctional base of FIG. 1.

FIG. 4 is a schematic view of a bag according to a first embodiment of the present disclosure, in which the bag is in a deflated state.

FIG. 5 is a schematic view of the bag of FIG. 4, in which the bag is in an inflated state.

FIG. 6 is an exploded view of the bag of FIG. 4.

FIG. 7 is a front view of a bag according to a second embodiment of the present disclosure.

FIG. 8 is a front view of the bag of FIG. 7, in which, a multifunctional base is not shown.

FIG. 9 is a front view of a bag according to a. third embodiment of the present disclosure.

FIG. 10 is a cross sectional view of the bag of FIG. 9.

FIG. 11 is a front view of a bag according to a fourth embodiment of the present disclosure.

FIG. 12 is a schematic view of a bag according to a fifth embodiment of the present disclosure.

FIG. 13 is a cross sectional view of the bag of FIG. 12.

FIG. 14 is a schematic view of a bag according to a sixth embodiment of the present disclosure.

FIG. 15 is a schematic view of a bag according to a seventh embodiment of the present disclosure.

FIG. 16 is a schematic view of a bag according to an eight embodiment of the present disclosure.

FIG. 17 is a schematic view of a bag according to a ninth embodiment of the present disclosure.

FIG. 18 is a schematic view of the bag of FIG. 17 in an unfolded state

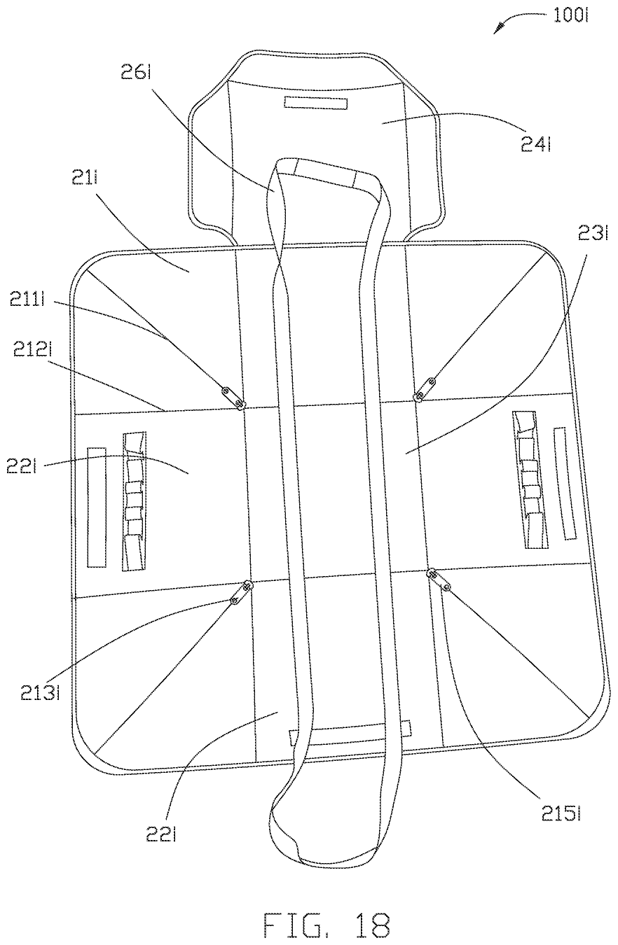

FIG. 19 is a schematic view of the bag of FIG. 17 in an folded state.

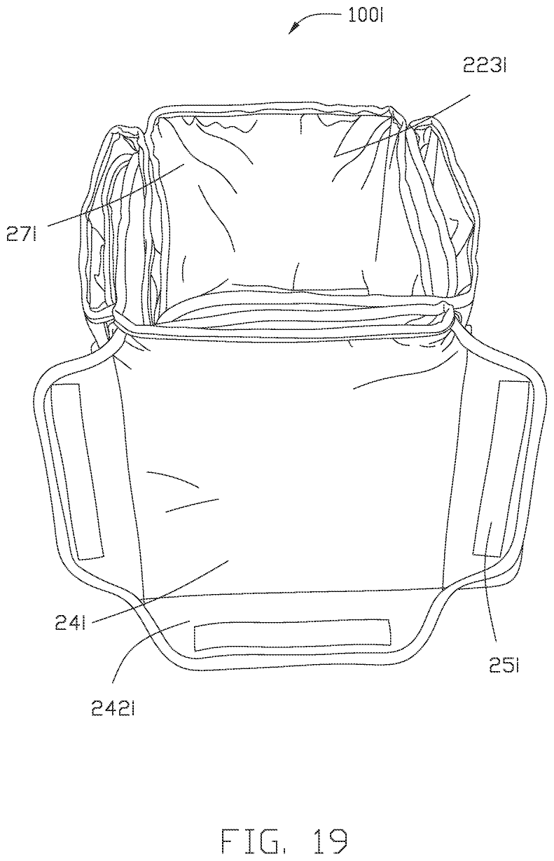

FIG. 20 is a schematic view of the bag of FIG. 17 in a pressed state.

FIG. 21 is a schematic view of a bag according to a tenth embodiment of the present disclosure.

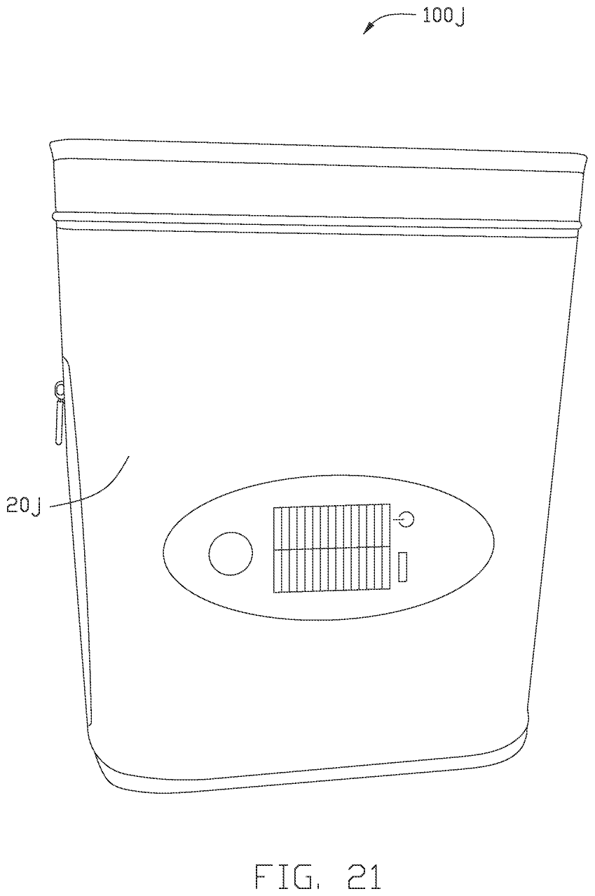

FIG. 22 is similar to FIG. 21, but shown form another view.

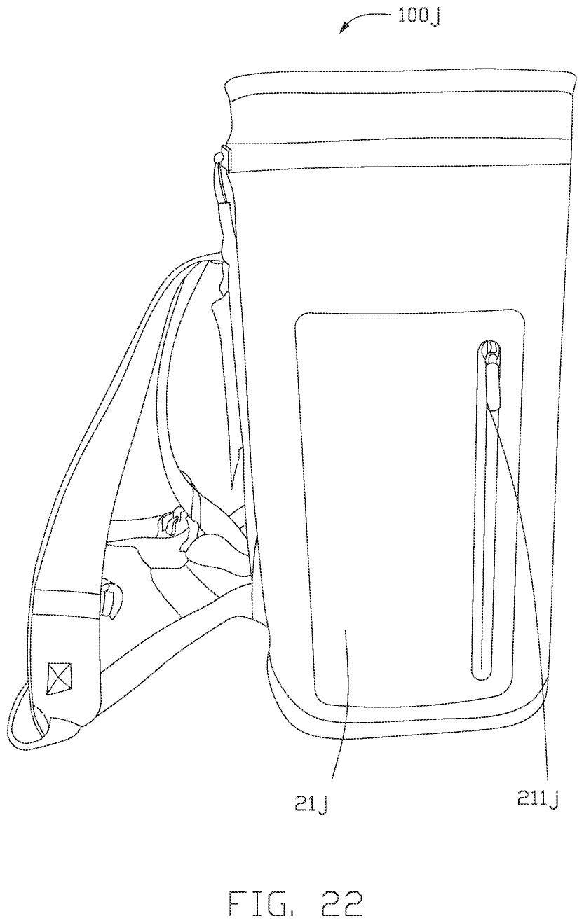

FIG. 23 is a schematic view of a bag according to an eleven embodiment of the present disclosure.

FIG. 24 is a schematic view of the bag of FIG. 23 in an open state.

FIG. 25 is a schematic view of a bag according to a twelve embodiment of the present disclosure.

FIG. 26 is a schematic view of the bag of FIG. 25 in a first open state.

FIG. 27 is a schematic view of the bag of FIG. 25 in a second open state.

FIG. 28 is a schematic view of a bag according to a thirteenth embodiment of the present disclosure.

FIG. 29 is a schematic view of a bag according to a fourteenth embodiment of the present disclosure.

FIG. 30 is a schematic view of a bag according to a fifteenth embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the application, “a plurality of” means two or more, unless otherwise specifically defined.

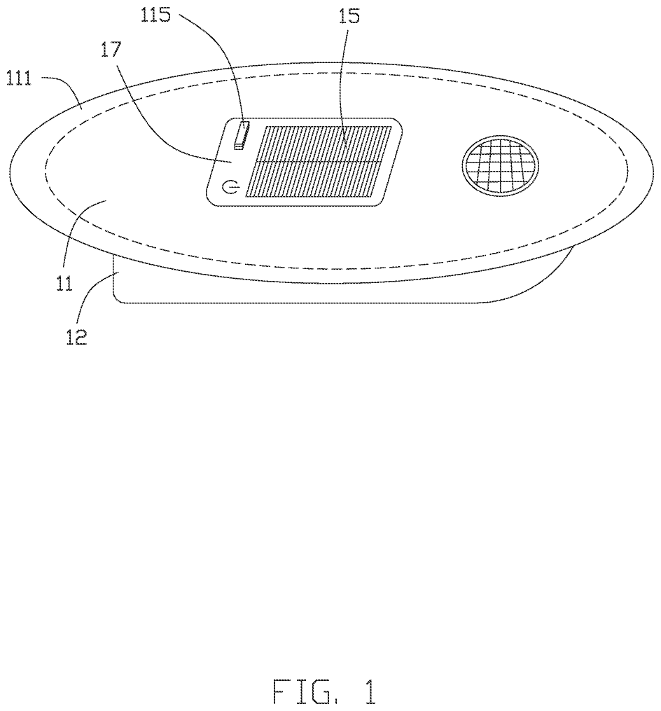

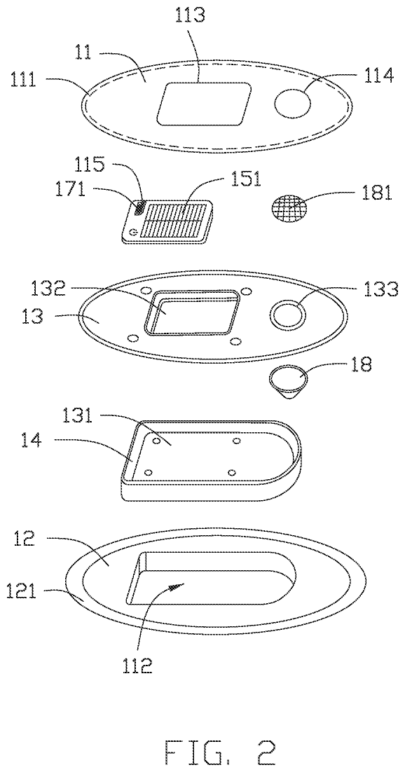

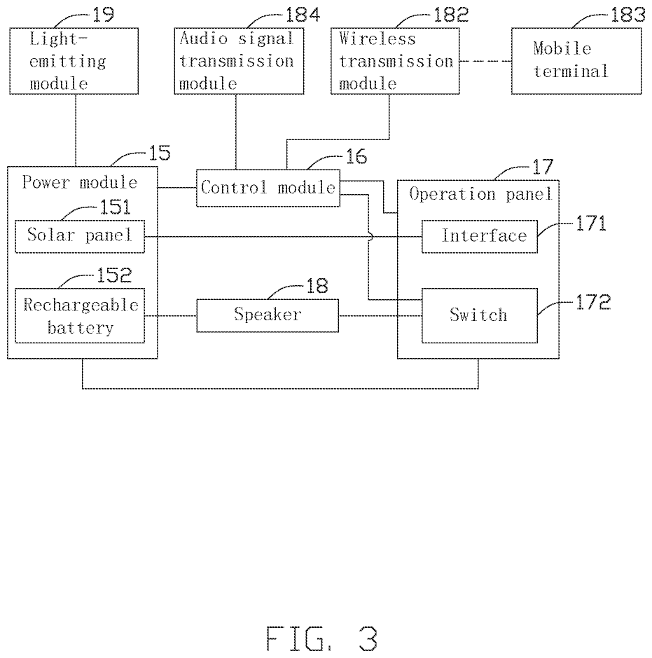

Referring to FIGS. 1 to 3, the present disclosure provides a multifunctional base 10. The multifunctional base 10 includes a first cover 11 and a second cover 12. The first cover 11 includes a first connecting edge 111 configured to sealingly connect the multifunctional base 10 with a bag, the first connecting edge 111 extends along a periphery of the first cover 11, the first connecting edge 111 is made of flexible material. The second cover 12 is connected with first cover 11 to form a receiving space 112. Some components, such as power module, control module, operation panel, speaker, light-emitting module, and the like, can be received in the receiving space 112 or arranged on the first cover 11, so that the multifunctional base 10 can provide user multi-functions.

In at least one embodiment, the first cover 11 is made of flexible material or rigid material, the second cover 12 is made of flexible material or rigid material. The rigid material may be Acrylonitrile Butadiene Styrene (ABS) plastic, Polyethylene (PE), Polypropylene (PP), and etc. The flexible material is soft waterproof material, such as polyvinyl chloride (PVC), Thermoplastic polyurethanes (TPU), Polystyrene (PS), and etc.

In at least one embodiment, the first connecting edge 111 is made of flexible material, such as soft thermoplastics, including but not limited to PVC and TPU.

In at least one embodiment, the second cover 12 includes a second connecting edge 121 made of flexible material, the second connecting edge 121 extends along a periphery of the second cover 12, the first connecting edge 111 is connected with the second connecting edge 121 by hot pressing, hot melting or ultrasonic, to connect the first cover 11 with the second cover 12.

In at least one embodiment, the multifunctional base 10 further includes a fixing plate 13, and a bottom shell 14 connected with the fixing plate 13 by inserting or clamping to define a cavity 131, the fixing plate 13 and the bottom shell 14 are both received in the receiving space 112. The first cover 11 covers an outer side of the fixing plate 13, and the second cover 12 covers an outer side of the bottom shell 14 and sealed with the first cover 11, so that the sealed receiving space 112 is formed between the second cover 12 and the first cover 11.

In at least one embodiment, the multifunctional base 10 further includes a power module 15 and a control module 16. The power module 15 is at least partially received in a first receiving groove 132 defined in the fixing plate 13. The control module 16 is received in the cavity 131 and electrically connected with the power module 15.

In at least one embodiment, the power module 15 is received in the first receiving groove 132 of the fixing plate 13, the first cover 11 covers the power module 15, and the first cover 11 is at least partially transparent.

In at least one embodiment, the power module 15 includes a solar panel 151, the solar panel 151 is received in the first receiving groove 132, exposed from a first through hole 113 of the first cover 11. The solar panel 151 may be sealingly connected with a side wall of the first through hole 113.

In at least one embodiment, the power module 15 includes a solar panel 151 solar panel 151 is received in the first receiving groove 132. The first cover 11 does not defines the first through hole 113, the first cover 11 is at least partially transparent, and covers the solar panel 151.

In at least one embodiment, the power module 15 further includes a rechargeable battery 152, the rechargeable battery 152 is electrically connected with the solar panel 151 and received in the cavity 131. During the daytime, the solar panel 151 collects power and transmits the power to the rechargeable battery 152 for storage, and the rechargeable battery 152 supplies power to speaker 18. The control module 16 includes a charging module (not shown), and a discharging module (not shown), the charging module and the discharging module are electrically connected with the rechargeable battery 152, and the charging module is mainly used for charging the rechargeable battery 152, for example, the rechargeable battery 152 can be charged by the solar panel 151 or an external charging device, and the discharging module enables the rechargeable battery 152 to charge an external mobile terminal.

In at least one embodiment, the multifunctional base 10 further includes an operation panel 17. The operation panel 17 is at least partially received in first receiving groove 132 and the first through hole 113 of the first cover 11, the operation panel 17 is electrically connected with the power module 15 and the control module 16. The operation panel 17 is sealingly connected with the side wall of the first through hole 113.

In at least one embodiment, the operation panel 17 includes an interface 171 exposed from the top surface of the first cover 11, the interface 171 is electrically connected with the power module 15. The interface 171 is connected with the charging module and the discharging module, and configured for connecting with external power supply, such as a charger or an externally chargeable mobile terminal; the rechargeable battery 152 is charged by the charger or the externally chargeable mobile terminal, or an external device is charged via the interface 171.

In at least one embodiment, the first cover 11 further includes a protecting cap 115, the protecting cap 115 is configured to cover or expose the interface 171. When the protecting cap 115 covers the interface 171, the protecting cap 115 seals the interface 171 with the first cover 11.

In at least one embodiment, the operation panel 17 includes a switch module 172 electrically connected with the control module 16. The switch module 172 is received in the cavity 131 and covered by the first cover 11, or the switch module 172 is exposed from the first through hole 113 of the first cover 11. The control module 16 is electrically connected with the switch module 172 which can control play or pause of playing content or music, and the switch module 172 can be a touch control panel or a push control panel.

In at east one embodiment, the multifunctional base 10 further includes a speaker 18 and a dust-proof net 181, both received in a second through hole 114 of the first cover 11 and a second receiving groove 133 defined in the fixing plate 13, the speaker 18 is electrically connected with the power module 15 and the control module 16. The dust-proof net 181 is configured to cover the speaker 18. The cavity 131 can enable the speaker 18 to have better sound effect and resonance. The periphery of the second through hole 114 of the first cover 11 is sealed with the dust-proof net 181.

In at least one embodiment, the multifunctional base 10 further includes a wireless transmission module 182, received in the cavity 131 and electrically connected with the control module 16. The wireless transmission module 182 can be wirelessly connected with an mobile terminal 183, such as mobile phones, tablet computers and the like, in a manner of Bluetooth wireless connection, and a signal is sent to the control module 16 by the mobile terminal 183.

In at least one embodiment, the multifunctional base 10 further includes an audio signal transmission module 184, received in the cavity 131 and electrically connected with the speaker 18 and the control module 16.

In at least one embodiment, the multifunctional base 10 further includes a light-emitting module 19, received in the cavity 131 and electrically connected with the power module 15 and the control module 16, the first cover 11 is at least partially transparent. The light emitting modes of the light-emitting module 19 is controlled by the switch module 172, and the light-emitting module 19 can be arranged on the inner side or the outer side of the control module 16 or on both sides or on the periphery of the control module 16. The light-emitting module 19 can be a LED lamp. In detail, the light-emitting module 19 include, but are not limited to, “SOS red light blinking”, blinking with music rhythm, RGB free colorful switching, and normally white light.

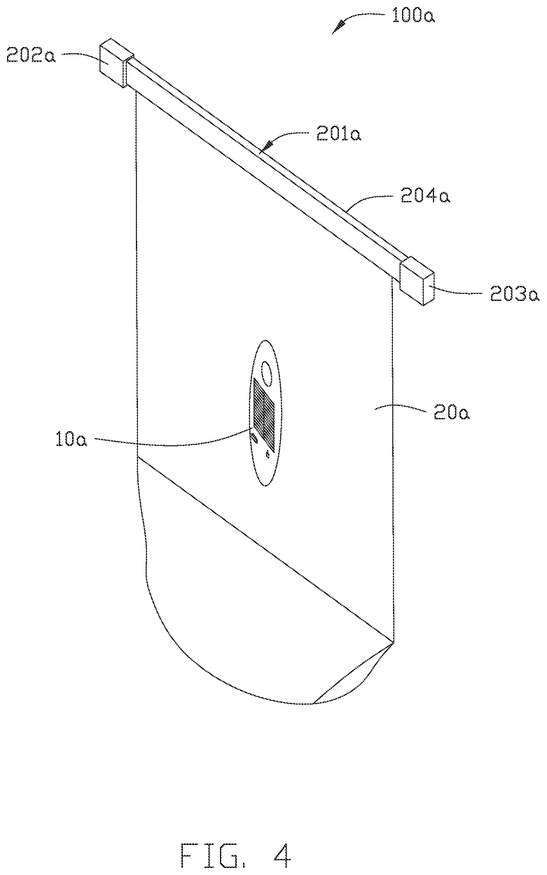

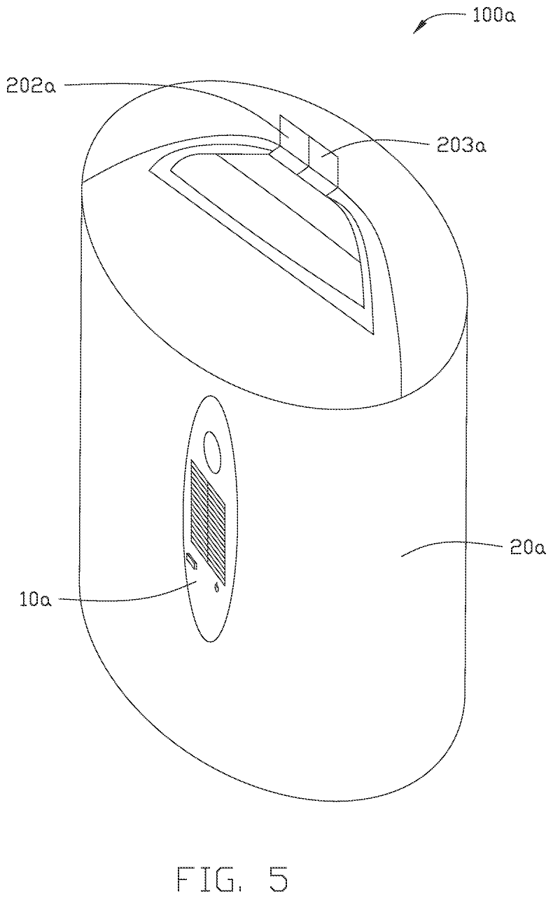

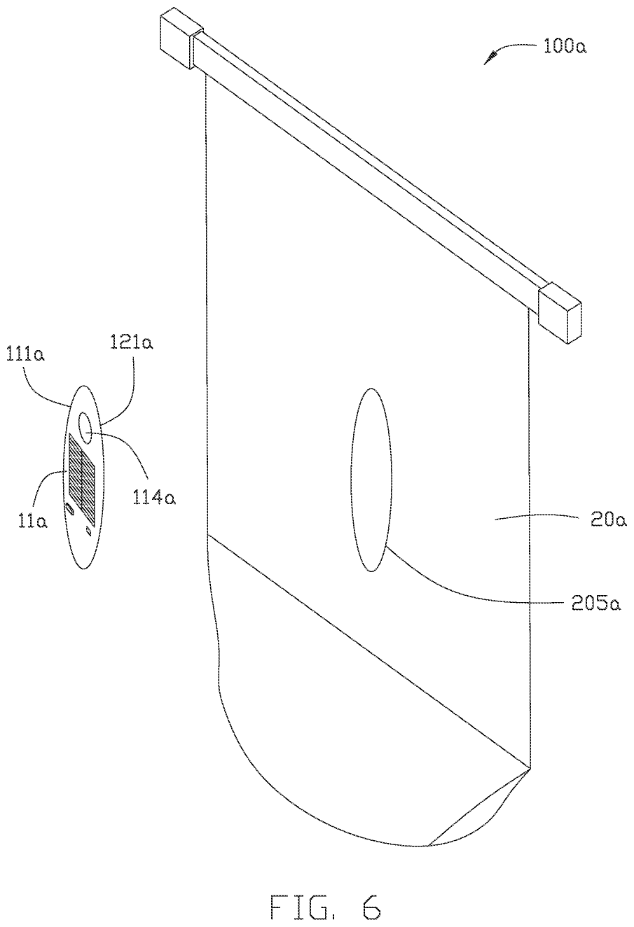

Referring to FIGS. 4 to 6, the present disclosure further provides a bag 100a according to a first embodiment. The bag 100a includes the above-mentioned multifunctional base 10a and a bag body 20a.

In at least one embodiment, the bag 1100a can be a roll top backpack.

In at least one embodiment, the bag 100a is made of a waterproof material, such as PVC, PU, 500D-1000D meshed PVC or TPU. or other polyethylene resin material.

In particular, it needs to be mentioned that the multifunctional base 10a in the present disclosure model can he used alone, that is, the multifunctional base 10a in the present disclosure model has a function of playing audio when it is not sealed with the bag 100a, without being affected by whether it is sealed with the bag 100a or not.

In at least one embodiment, the body 20a has an opening 201a, two sides of the opening 201a are provided with a first connecting part 202a and a second connecting part 203a, the first connecting part 202a and the second connecting part 203a can be correspondingly connected, and the first connecting part 202a and the second connecting part 203a can be connected in a buckling mode, a snap-fastening mode, a hook and loop fastening mode or a magnetic attraction mode. A rolling strip 204a is arranged between the first connecting part 202a and the second connecting part 203a. After the opening 201a is rolled up along the rolling strip 204a towards the direction of the bag body 20a, the first connecting part 202a and the second connecting part 203a are clamped, the bag 100a is in an inflated state to form an air bag shape, and the first connecting part 202a and the second connecting part 203a can form a handle.

In at least one embodiment, a placing hole 205a is formed in the bag body 20a, the multifunctional base 10a is sleeved in the placing hole 205a, the first connecting edge 111a and/or the second connecting edge 121a is a fused edge which can be subjected to hot pressing, hot melting or ultrasonic, and the first connecting edge 111a and/or the second connecting edge 121a is sealed with a side wall of the placing hole 205a, or sealed with a periphery of a side wall of the placing hole 205a, to achieve a waterproof state.

In at least one embodiment, after the multifunctional base 10a is sealed in the placing hole 205a, the opening 201a of the bag 100a is rolled up to form a state in which the outside of the bag 100a is waterproof while the inside of the bag 100a is also waterproof. In addition, due to the fact that the second through hole 114a corresponding to the speaker is formed in the first cover 11a, the waterproof and sound transmission effect can be achieved after the second cover is sealed with the first cover 11a.

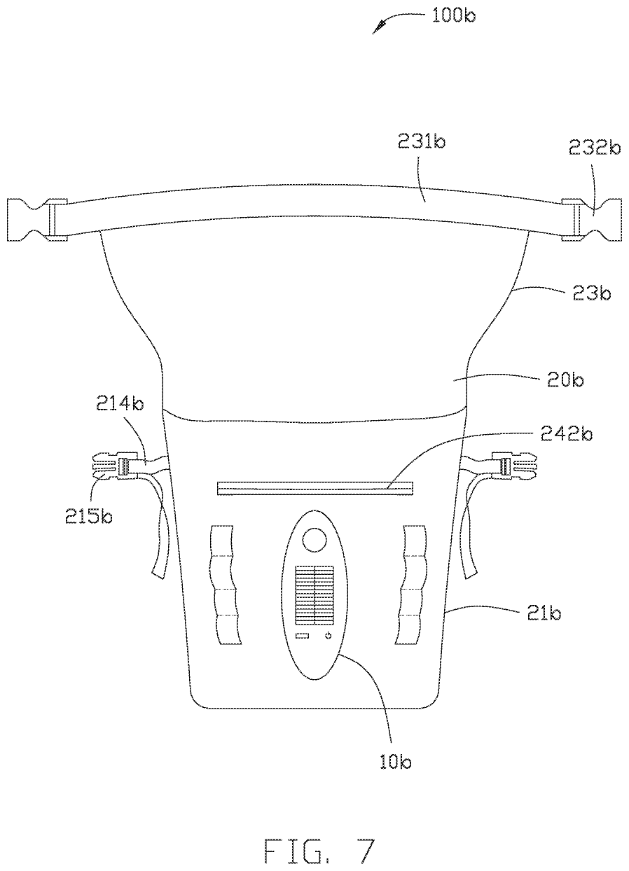

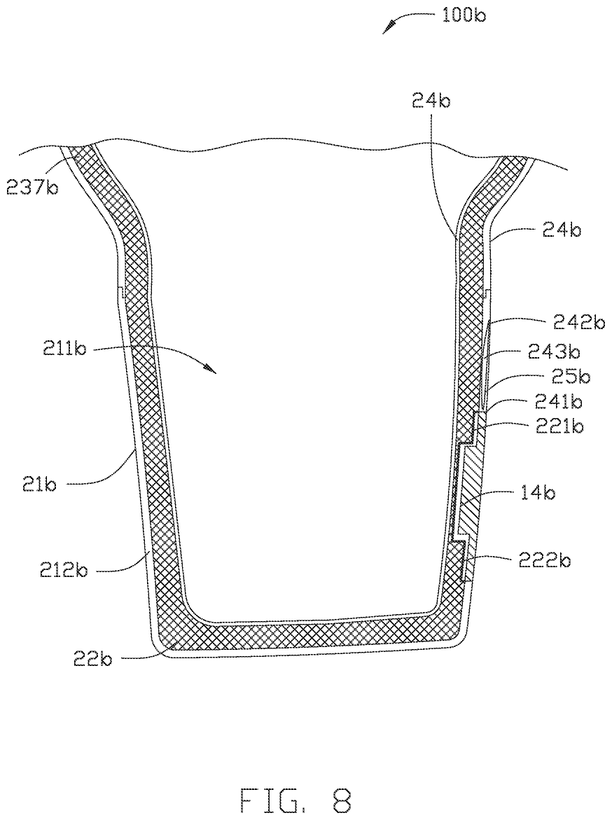

Referring to FIGS. 7 and 8, the present disclosure further provides a bag 100b according to a second embodiment. The bag 100b includes the above-mentioned multifunctional base 10b and a bag body 20b. The bag body 20b includes a rigid portion 21b, an insulating element 22b attached on an inner side of the rigid portion 21b, and a flexible portion 23b connected with an edge of an upper opening 211b of the rigid portion 21b. The multifunctional base 10b is sealed on an outer side of the rigid portion 21b. The rigid portion 21b can stretch the bag 100b, and the flexible portion 23b facilitates the opening and closing the upper opening 211b of the rigid portion 21b. The flexible portion 23b is made of TPU or PVC.

In at least one embodiment, the insulating element 22b has a function of thermal insulation to keep objects received in the bag 100b cool or hot, so the bag 100b can be an ice bag, or an insulation bag.

In at least one embodiment, the insulating element 22b is snatched with the rigid portion 21b in shape. The insulating element 22b may be an insulating layer.

In at least one embodiment, the flexible portion 23b may be connected with the rigid portion 21b through hot pressing, screwing, blister, or fusion welding.

In at least one embodiment, the insulating element 22b is made of foam, sponge, or the like.

In at least one embodiment, the insulating element 22b has a third receiving groove 221b, the multifunctional base 110b is received in the third receiving groove 221b, and the first connecting edge is sealingly connected with a periphery of the third receiving groove 221b. In detail, the bottom shell 14b can be received in the third receiving groove 221b.

In at least one embodiment, the bag 100b further includes two waterproof elements 24b connected with each other and defining the opening 211b. The waterproof elements 24b cooperatively form an insulating space 212b for receiving the insulating element 22b. So that, the bag 100b not only has the waterproof function, but also has the heat preservation function. The waterproof element 24b is made of TPU or PVC.

In at least one embodiment, the waterproof element 24b has a function of preventing water from penetrating into the bag 100b, so the bag 100b can also be a water-proof bag.

In at least one embodiment, the waterproof element 24b is matched with the rigid portion 21b in shape. The waterproof element 24b may be an waterproof layer.

In at least one embodiment, one of the waterproof elements 24b defines a third through hole 241b, the multifunctional base 10b is received in third receiving groove 221b and exposed from the third through hole 241b, the multifunctional base 10b is sealingly connected with a periphery of the third through hole 241b through the first connecting edge and/or the second connecting edge.

In at least one embodiment, the multifunctional base 10b is received in third through hole 241b and the third receiving groove 221b.

In at least one embodiment, the bag 100b further includes a protecting layer 222b arranged in the third receiving groove 221b of the insulating element 22b, to separate the insulating element 2b from the multifunctional base 10. The protecting layer 222b is made of TPU or PVC.

In at least one embodiment, the bag 100b further includes an inner layer 25b attached with the inner side of one waterproof element 24b which has an opening 242b, the inner layer 25b is adjacent to the opening 242b, so that, the inner layer 25b and the waterproof element 24 cooperatively form a pocket 243b. The opening 242b is strip shaped.

In at least one embodiment, the rigid portion 21b further includes a surface layer (not shown), and two belts (not shown) connected with the surface layer. Or, a handle (not shown) can be connected with the surface layer.

In at least one embodiment, a bandage 231b is arranged at an upper opening of the flexible portion 23b, to close or open the upper opening of the flexible portion 23b. Two clamping elements 232b are arranged on both ends of the bandage 231b, respectively. Two connecting belts 214b are arranged on the rigid portion 21b. each connecting belts 214b is provided with a connecting element 215b. The clamping elements 232b may be clamped with the connecting elements 215b.

In at least one embodiment, the bandage 231b may roll up to bring the flexible portion 23b to roll up simultaneously, then the clamping elements 232b may be clamped with the connecting elements 215b to close the opening of rigid portion 21b. The rolled up flexible portion 23b also play the heat preservation function.

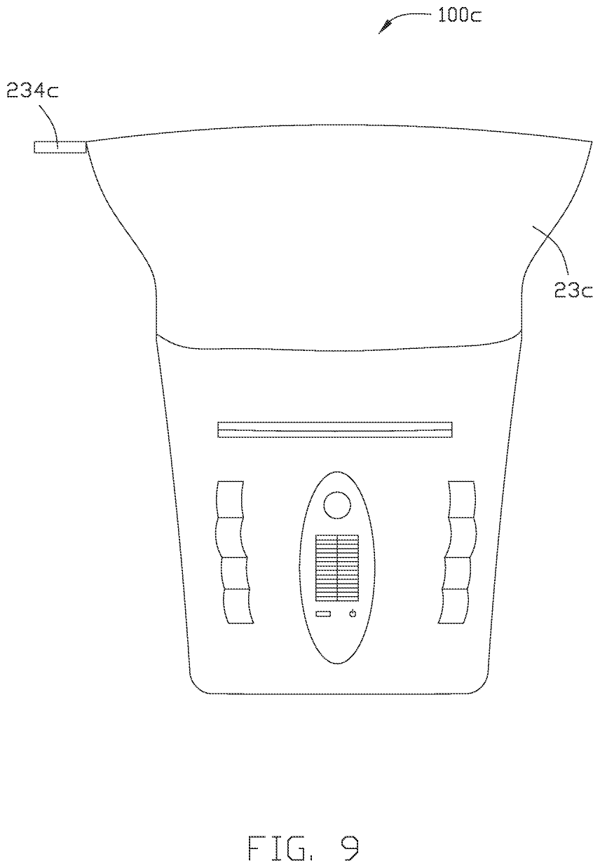

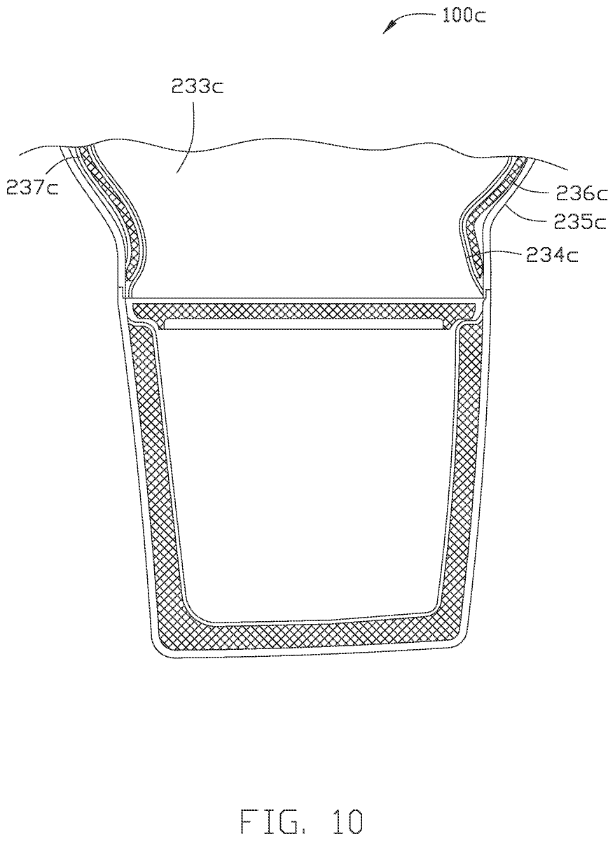

Referring to FIGS. 9 and 10, the present disclosure further provides a bag 100c according to a third embodiment. The bag 100c is similar to the bag 100b in structure. The difference between the bag 100c and bag 100b includes: the opening 233c of the flexible portion 23c is closed by a zipper 234c.

In at least one embodiment, the bag 100b can be a picnic bag, an ice bag, an insulation bag, a camping bag, an outdoor bag, a laptop bag, a children's bag, or the like.

In at least one embodiment, the opening 233c of the flexible portion 23c can be closed by hook and loop fasteners (not shown), or a buckle structure (not show

In at least one embodiment, the flexible portion 23c includes an inner flexible layer 234c and an outer flexible layer 235c, an edge of the inner flexible layer 234c is connected with an edge of the outer flexible layer 222c, and a heat preservation layer 236c is received in a heat preservation cavity 237c formed by the inner flexible layer 234c and the outer flexible layer 235c. In this way, the heat preservation effect of the flexible portion 23c is improved.

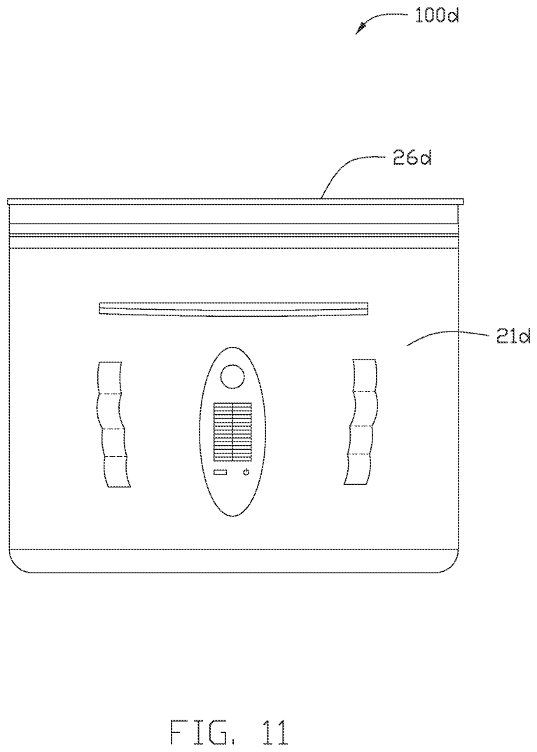

Referring to FIG. 11, the present disclosure further provides a bag 100d according to a fourth embodiment. The bag 100d is similar to the bag 100b in structure. The difference between the bag 100d and bag 100b includes: the bag 100d does not have the flexible portion, the rigid portion 21d is covered by a protecting cover 26d.

In at least one embodiment, the protecting cover 26d is made of PVC or TPU.

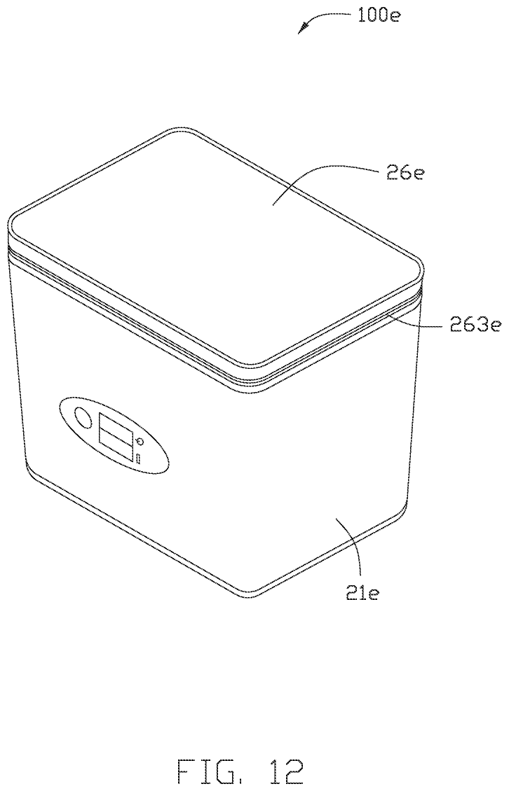

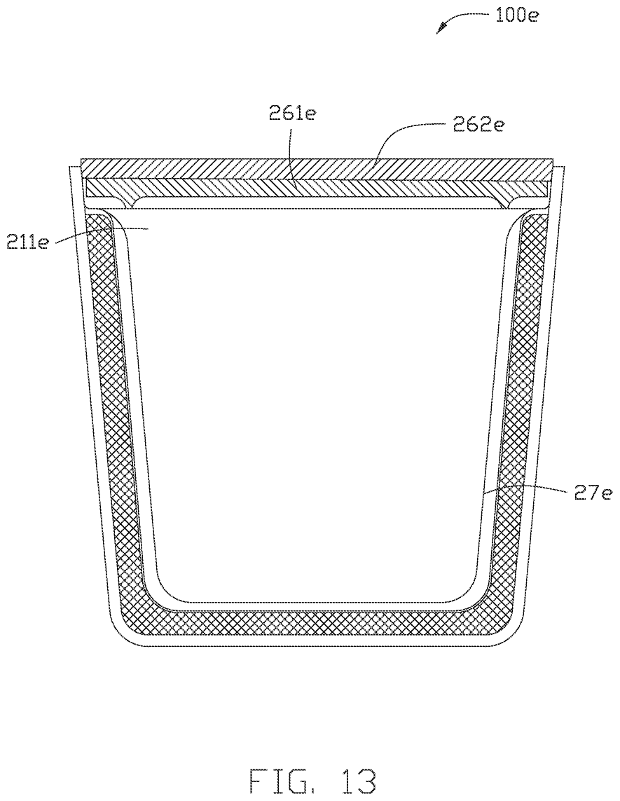

Referring to FIGS. 12 and 13, the present disclosure further provides a bag 1100e according to a fifth embodiment. The bag 100e is similar to the bag 100d in structure. The difference between the bag 100e and bag 100d includes: the protecting cover 26e includes a first protecting cover 261e and a second protecting cover 262e. The first protecting cover 261e is arranged on an inner side of the second protecting cover 262e and covers the opening 211e of the rigid portion 21e.

In at least one embodiment, the second protecting cover 262e is connected with the rigid portion 21e through a zipper 263e.

In at least one embodiment, the bag 100e includes a waterproof element 27e received in the rigid portion 21e. The waterproof element 27e is matched with the rigid portion 21e in shape. The waterproof element 27e is detachably connected with the rigid portion 21e. The waterproof element 27e may be a waterproof bag.

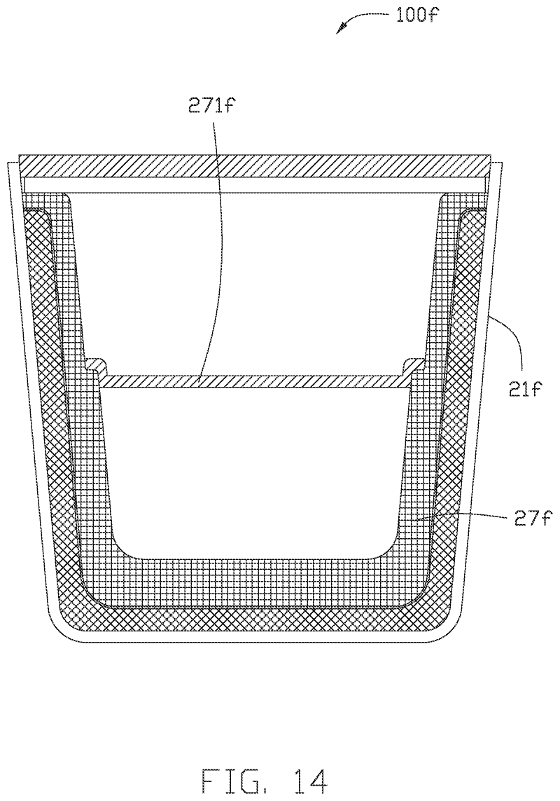

Referring to FIG. 14, the present disclosure further provides a bag 100f according to a sixth embodiment. The bag 100f is similar to the bag 100e in structure. The difference between the bag 100f and bag 1100e includes: the waterproof element 27f is a waterproof box.

In at least one embodiment, the waterproof element 27f is matched with the rigid portion 21f in shape.

In at least one embodiment, the waterproof element 27f is detachably connected with the rigid portion 21f.

In at least one embodiment, the waterproof element 27f includes a separating plate 271f. The separating plate 271f may be clamped in the waterproof box. The separating plate 271f defines a plurality of vent holes (not shown).

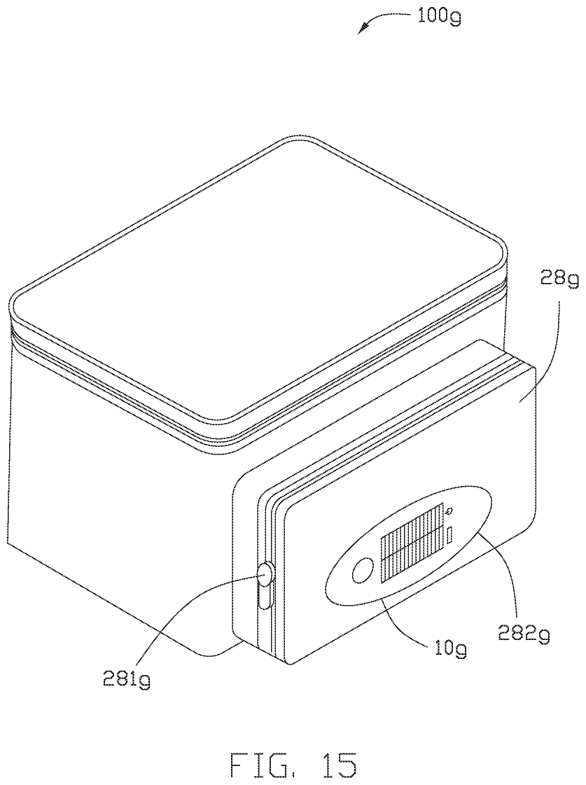

Referring to FIG. 15, the present disclosure further provides a bag 100g according to a seventh embodiment. The bag 100g is similar to the bag 100e in structure. The difference between the bag 100g and bag 100e includes: the bag 100e includes a first carriage bag 28g, the multifunctional base 10g is arranged on the first carriage bag 28g.

In at least one embodiment, the first carriage bag 28g can be opened or closed through a zipper 281g.

In at least one embodiment, the first carriage bag 28g defines a fourth through hole 282g, the multifunctional base 10g is received in fourth through hole 282g and sealingly connected with a periphery of the fourth through hole 282g through the first connecting edge.

In at least one embodiment, the first carriage bag 28g is provided with a lifting belt (not shown).

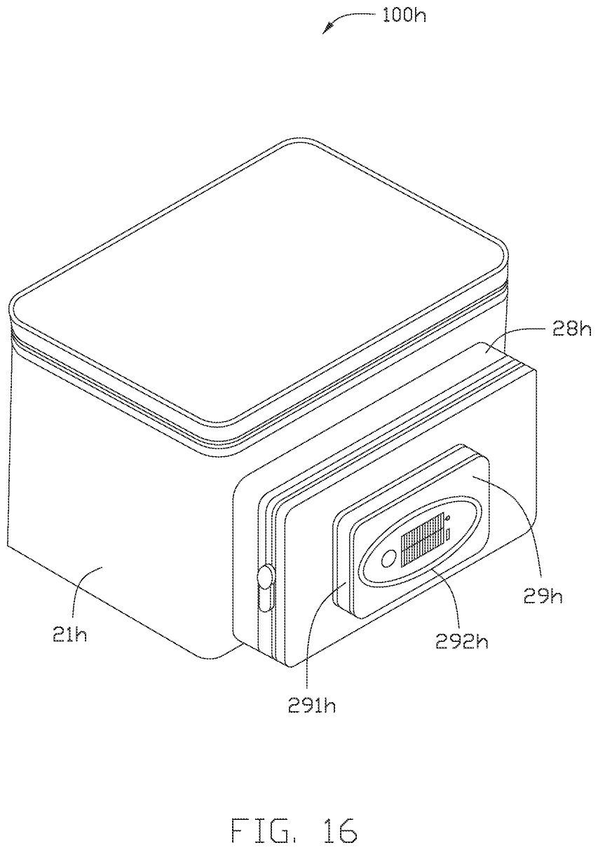

Referring to FIG. 16, the present disclosure further provides a bag 100h according to an eighth embodiment. The bag 100h is similar o the bag 100g in structure. The difference between the bag 100h and bag 100g includes: the bag 100h includes a second carriage bag 28h, and a third carriage bag 29h detachably connected with the second carriage bag 28h, the multifunctional base 10h is sealingly connected with the third carriage bag 29h.

In at least one embodiment, the third carriage bag 29h is detachably connected with the second carriage bag 28h through a connecting element 291h, such as a zipper. Preferably, the third carriage bag 29h can be separated from the second carriage bag 28h.

In at least one embodiment, the third carriage bag 29g defines a fifth through hole 292h, the multifunctional base 10h is received in fifth through hole 292h and sealingly connected with a periphery of the fifth through hole 292h through the first connecting edge.

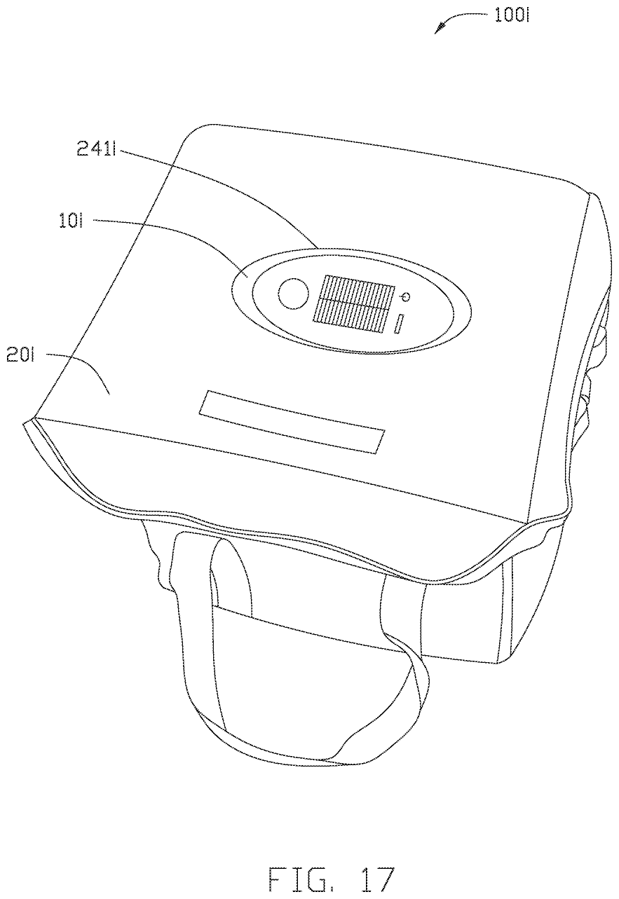

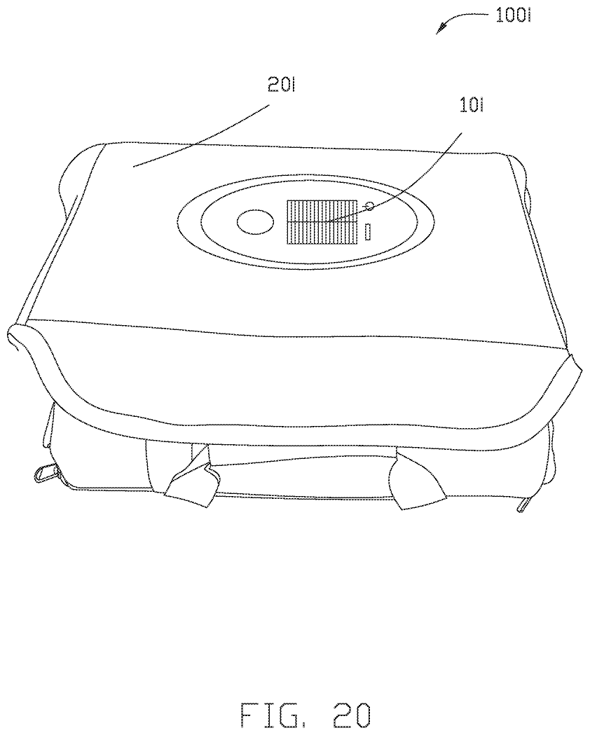

Referring to FIGS. 17 and 20, the present disclosure further provides a bag 100i according to a ninth embodiment. The bag 100i is similar to the bag 100e in structure. The difference between the bag 100i and bag 100e includes: the bag body 20i has a one piece structure and can be formed by folding a one piece of cloth, and the multifunctional base 10i is arranged on a top surface of the bag body 20i.

In at least one embodiment, the multifunctional base 10i is arranged a sixth through hole 241i defined in the top surface of the bag body 20i.

In at least one embodiment, the bag body 20i includes four folding portions 21i, four side walls 22i, a bottom wall 23i, and a cover 24i connected to one side wall 23i, the four folding portions 21i are arranged at four corners of the one piece of cloth, respectively. Each side wall 22i is connected with one corresponding folding portion 21i. And the four side walls 22i are connected with the bottom wall 23i, or the four side walls 22i and the four folding portions 21i are all connected with the bottom 23i. The cover 24i has the through hole 241i. The four folding portions 22i can be folded to remain the side walls 22i to be in an upright state, so that the folding portions 22i, the side walls 22i, the bottom wall 23i, and the cover 24i cooperatively form the bag body 20i.

In at least one embodiment, each folding portion 21i has a diagonal line 211i, the folding portion 21i can be folded along the diagonal line 211i. Each folding portion 211 also includes two connecting sides 212i, when the folding portion 21i is folded along the diagonal line 211i, the two connecting sides 212i can be connected with each other. Each folding portion 21i further includes a first connecting structure 213i, the first connecting structure 213i includes two zippers (not shown) respectively arranged on the two connecting sides 212i, and a zipper head 215i movably connected with the zippers and configured to connect the two connecting sides 212i together. After the bag body 20i is folded, an opening 23i is formed.

In at least one embodiment, the bag body 20i further includes a second connecting structure 25i configured to detachably connect the cover 24i with at least one of the side wall 22i. The second connecting structure 25i is a hook and loop fastener, a buckle fastener, or a snap fastener.

In at least one embodiment, the cover 24i has three extending edges 242i. After the cover 24i covers the opening 223i of the bag body 20i, the extending edges 242i are attached with the side walls 22i.

In at least one embodiment, the bottom wall 23i can be squeezed, and the bag 100i can be pressed to have a small volume.

In at least one embodiment, the bag 100i further includes a bandage 26i.

In at least one embodiment, the bag 100i further includes a waterproof layer 27 attached with inner surfaces of the folding portions 21i, the side walls 22i, the bottom wall 23i, and the cover 24i.

Referring to FIGS, 21-22, the present disclosure further provides a bag 100j according to a tenth embodiment. The bag 100j is similar to the bag 100e in structure. The difference between the bag 100j and bag 100e includes: the bag body 20j is cuboid shaped.

In at least one embodiment, the bag 100j has a side pocket 21j. The side pocket 21j has a zipper 211j to close or open the side pocket 21j.

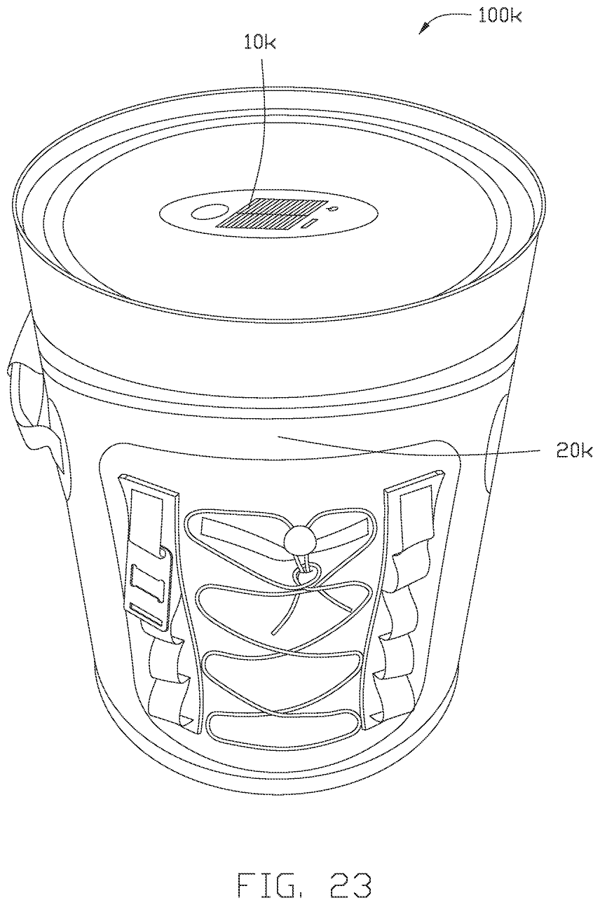

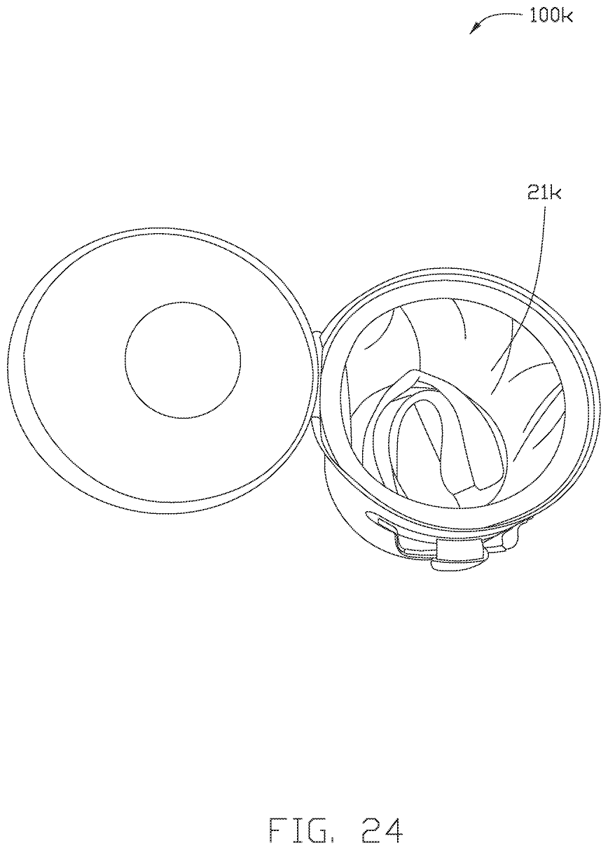

Referring to FIGS. 23-24, the present disclosure further provides a bag 100k according to an eleventh embodiment. The bag 100k is similar to the bag 100e in structure. The difference between the bag 100k and bag 100e includes: the bag body 20k is cylinder shaped, and the multifunctional base 10k is arranged on the top surface of the bag body 20k.

In at least one embodiment, an inner space 21k of the bag body 20k is cylindrical shaped.

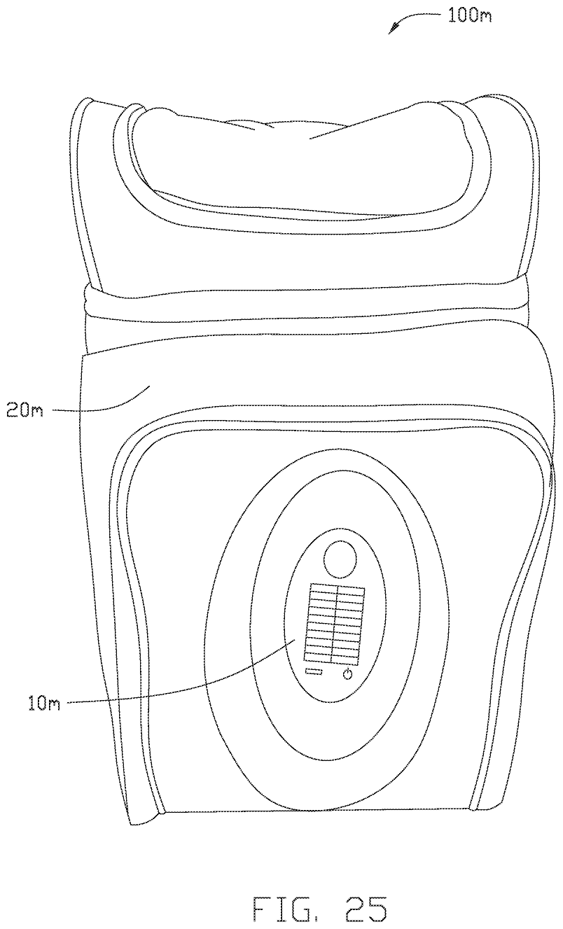

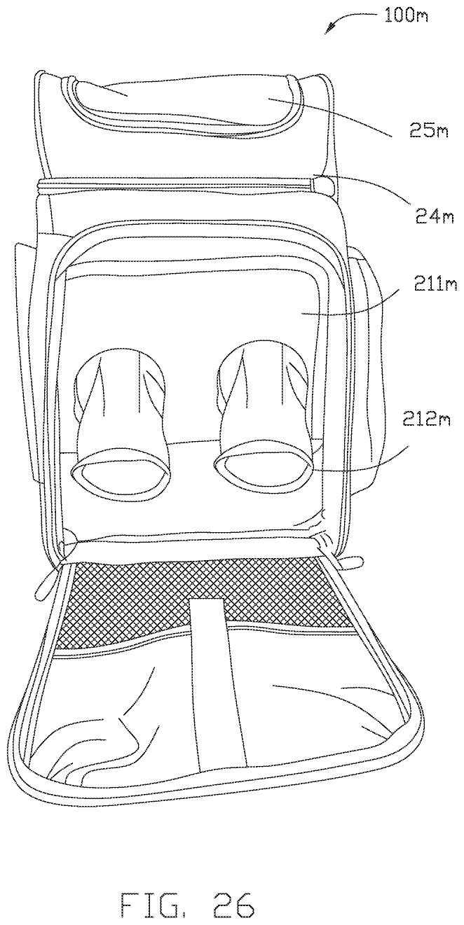

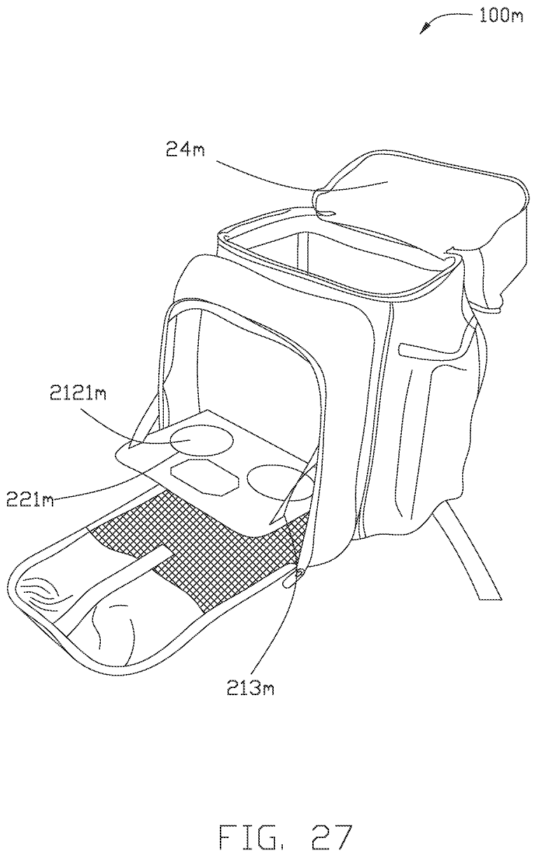

Referring to FIGS. 25-27, the present disclosure further provides a bag 100m according to a twelfth embodiment. The bag 100m is similar to the bag 100e in structure. The difference between the bag 100m and bag 100e includes: the bag body 20m includes a fourth carriage bag 21m.

In at least one embodiment, the fourth carriage bag 21m includes a supporting plate 211m rotatably received in the fourth carriage bag 21m, at least one receiving element 212m connected with the supporting plate 211m, and at least one connecting belt 213m. The supporting plate 211m is rotatably connected with an inner wall of the fourth carriage bag 21m, one end of the connecting belt 213m is connected with the inner wall of the fourth carriage bag 21m, the other end of the connecting belt 213m is connected with the supporting plate 211m. The supporting plate 211m defines a via hole 221m, the receiving element 212m has a receiving space 2121m, the receiving space 2121m is communicated with the via hole 221m, when the supporting element 211m is rotated to substantially parallel to the ground, and the supporting element 211m is held by the connecting belt 213m, cup, umbrella, or the like can be placed into the receiving space 2121m through the via hole 221m. It should be understood that, an angle between the supporting element 211m and the ground can be adjusted by a length of the connecting belt 213m.

In at least one embodiment, the bag body 20m further includes a cover 24m and a fourth carriage bag 25m, the fourth carriage bag 25m is connected with the cover 24m.

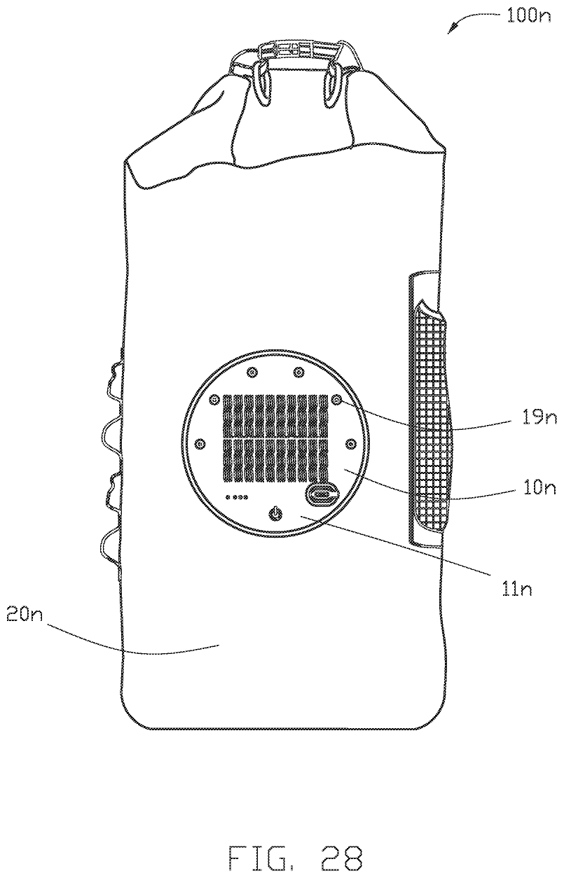

Referring to FIG. 28, the present disclosure further provides a bag 100n according to a thirteenth embodiment. The bag 100n is similar to the bag 100a in structure. The difference between the bag 100n and bag 100a includes: the multifunctional base 10n includes a plurality of light-emitting modules 19n, and the light-emitting modules 19n are arranged on the first cover 11n. So that, the bag 100n can emit light. The multifunctional base 10n can be arranged on a bottom of the bag body 20n, or arranged on an outer surface of the bag body 20n. The light-emitting modules 19n can emit light inward and/or outward the body.

In at least one embodiment, the light-emitting modules 19n are spaced apart from each other.

In at least one embodiment, the bag body 20n is inflatable.

In at least one embodiment, the bag body 20n is at least partially transparent.

In at least one embodiment, the multifunctional base 10n is sealingly connected with the bag body 20n. Or the bag body 20n defines a through hole (not labeled), the multifunctional base 10n is sealingly connected with a periphery of the through hole.

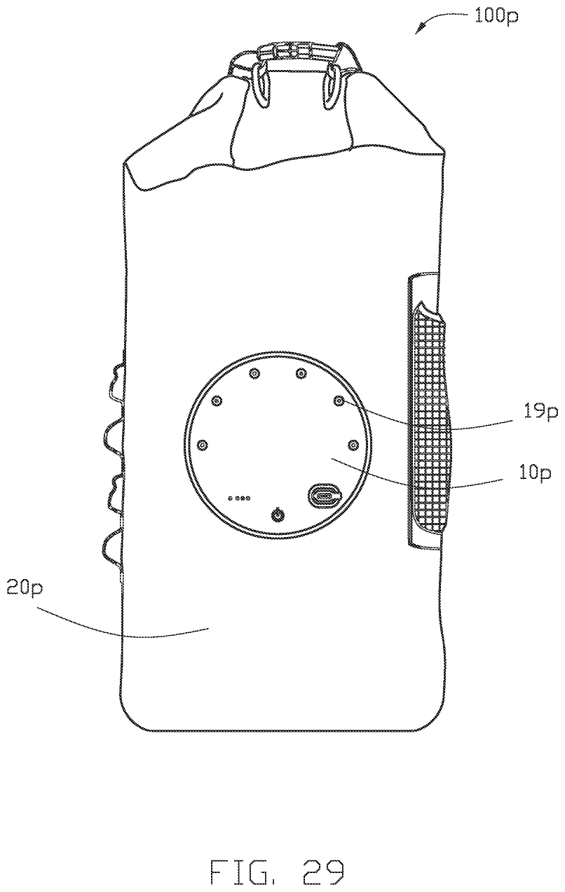

Referring to FIG. 29, the present disclosure further provides a bag 100p according to a fourteenth embodiment. The bag 100p is similar to the bag 100n in structure. The difference between the bag 100p and bag 100n includes: the multifunctional base lop does not include the solar panel.

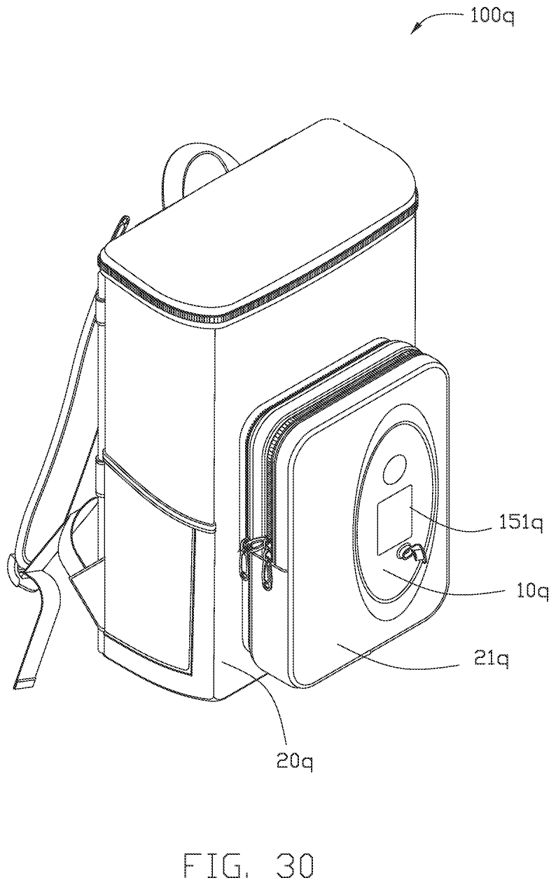

Referring to FIG. 30, the present disclosure further provides a bag 100q according to a fifteenth embodiment. The bag 100q is similar to the bag 100j in structure. The difference between the bag 100q and bag 100j includes: a fifth carriage bag 21q is detachably connected with the bag body 20q.

It should be understood that, the fifth carriage bag 21q can be separated from the bag body 20q.

In at least one embodiment, the multifunctional base 110q is sealing connected with the fifth carriage bag 21q.

In at least one embodiment, the multifunctional base 10q can include the solar panel 151q.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A multifunctional base, comprising:
a first cover, comprising a first connecting edge made of flexible material and extended along a periphery of the first cover, the first connecting edge is configured to sealingly connect the multifunctional base with an object; and
a second cover, the second cover is connected with first cover to define a receiving space.

2. The multifunctional base according to claim 1, wherein the second cover comprises:
a second connecting edge, made of flexible material and extended along a periphery of the second cover, the first connecting edge is sealingly connected with the second. connecting edge.

3. The multifunctional base according to claim 1, wherein further comprising:
a fixing plate, received in the receiving space; and
a bottom shell, received in the receiving space and connected with the fixing plate to define a cavity.

4. The multifunctional base according to claim 3, wherein further comprising:
a control module, received in the cavity; and
a power module, at least partially received in the cavity and electrically connected. with the control module.

5. The multifunctional base according to claim 4, wherein the power module comprises:
a solar panel, the solar panel is arranged on the fixing plate and the first cover is at least transparent; or the first cover defines a first through hole, and the solar panel is arranged on the fixing plate and exposed from the first through hole.

6. The multifunctional base according to claim 5, wherein the power module further comprises:
a rechargeable battery, electrically connected with the solar panel and received in the cavity.

7. The multifunctional base according to claim 4. wherein further comprising:
an operation panel, electrically connected with the power module and the control module, the operation panel is arranged on the fixing plate and attached with the first cover; or the first cover defines a first through hole, and the operation panel is arranged on the fixing plate and exposed from the first through hole.

8. The multifunctional base according to claim 4, further comprising:
a speaker, electrically connected with the power module and the control module, the speaker is arranged on the fixing plate and attached with the first cover; or the first cover defines a second through hole, the speaker is arranged on the fixing plate and exposed. from the second through hole.

9. The multifunctional base according to claim 4, wherein
the multifunctional base further comprises a light-emitting module, electrically connected with the power module and the control module, the light-emitting module is received in the cavity, and the first cover is at least partially transparent; or
the multifunctional base further comprises a plurality of light-emitting modules, spaced apart from each other and electrically connected with the power module and the control module, the light-emitting modules are arranged on the first cover.

10. A bag, comprising:
a multifunctional base as recited in claim 1; and
a bag body, the multifunctional base is sealingly connected with the bag body.

11. The bag according to claim 10, wherein
the multifunctional base is sealingly connected with a top surface of the bag body; or
the multifunctional base is sealingly connected with a front surface of the bag body.

12. The bag according to claim 10, wherein further comprising:
an insulating element, for thermal insulation, the insulating element defines a receiving groove, the multifunctional base is received in the receiving groove, and the first connecting edge is sealingly connected with a periphery of the receiving groove by the first connecting edge and exposed from the bag body.

13. The bag according to claim 12, wherein the bag body comprises:
a waterproof element, for preventing water from penetrating into the bag, the waterproof element is arranged adjacent to the insulating element, the waterproof element defines a third through hole communicated with the receiving groove, the multifunctional base is exposed from the third through hole and sealingly connected with a periphery of the third through hole by the first connecting edge.

14. The bag according to claim 10, wherein further comprising:
a first carriage bag, attached with the bag body, the multifunctional base is sealingly connected with the first carriage bag by the first connecting edge.

15. The bag according to claim 10, wherein further comprising:
a second carriage bag, attached with the bag body; and
a third carriage bag, detachably attached with the second carriage bag, the multifunctional base is sealingly connected with third carriage bag by the first connecting edge.

16. The bag according to claim 10, wherein the bag body comprises:
a first protecting cover; and
a second protecting cover, connected with the first protecting cover, the first protecting cover and the second protecting cover are configured to cover an opening of the bag body.

17. The bag according to claim 10, wherein the bag body comprises a one piece structure, the bag body comprises:
a plurality of folding portions, arranged at corners of the bag body respectively;
a plurality of side walls, each side wall is connected with one corresponding folding portion; and
a bottom wall, connected with the side walls, the folding portions are folded to remain the side walls to be in an upright state, so that the folding portions, the side walls, and the bottom wall cooperatively form the bag body.

18. The bag according to claim 17, wherein each of the folding portions comprises:
a diagonal line,
two connecting sides; and
a connecting structure, the folding portion is folded along the diagonal line, and the connecting sides are connected together by the connecting structure.

19. The bag according to claim 10, wherein the bag further comprises a fourth carriage bag, the fourth carriage bag comprises:
a supporting plate, rotatably connected with an inner wall of the fourth carriage bag, the supporting plate defines a via hole; and
at least one receiving element, connected with the supporting plate, the receiving element defines a receiving space communicated with the via hole.

20. The bag according to claim 19, wherein the fourth carriage bag comprises:
a connecting belt, one end of the connecting belt is connected with the inner wall of the fourth carriage bag, another end of the connecting belt is connected with the supporting plate.
